(19) United States
(12) Patent Application Publication
(10) Pub. No.: US 2009/0238529 A1
(43) Pub. Date: Sep. 24, 2009

(54) Fiber optic splitter carrier

(76) Inventors: George I. Wakileh, Batavia, IL (US); Jerome A. Maloney, Sugar Grove, IL (US); Simon Shen-Meng Chen, Palatine, IL (US); Eduardo Leon, Woodridge, IL (US)

Correspondence Address: HARNESS, DICKEY, & PIERCE, P.L.C, 7700 Bonhomme, Suite 400, ST. LOUIS, MO, 63105, US

(21) Appl. No.: 12/079,073

(22) Filed: Mar. 24, 2008

(51) Int. Cl. G02B 6/00

(52) U.S. Cl. 385/135; 385/136

(57) ABSTRACT

A carrier for a fiber optic cable splitter having a fastener and orienting a cable splitter is disclosed. A fiber distribution hub having a mounting plate with a fiber optic cable splitter carrier and splitter attached and a method of installing fiber optic cable in a fiber distribution hub are also disclosed.

### FIELD

The present disclosure relates to carriers for fiber optic cable splitters for telecommunications fiber distribution hubs.

### BACKGROUND

The statements in this section merely provide background information related to the present disclosure and may not constitute prior art.

A fiber distribution hub (FDH) is a metallic or a non-metallic enclosure that houses a plurality of fiber optic feeder fibers and distribution fibers. Depending on the specific applications, the feeder fiber can either be split and then connected to a distribution side or connected directly, i.e. without splitting, to a distribution side of the FDH. From the distribution side of an FDH, distribution fibers leave the FDH and are routed to other locations.

A typical fiber distribution hub includes one or more optical splitters that receive data signals via one or more fiber optic input lines. The splitters are often attached to a panel via a carrier or adapter. The panel to which the splitter is attached usually includes, among other things, connection points, parking points and routing elements for the fiber optic cable. The splitters divide each input data signal into a plurality of signals sent to a plurality of output ports of the respective splitter. Fiber optic jumper cables are connected between the splitter output ports and other connection points within the FDH. The jumpers exit the splitter in a direction perpendicular the panel to which the splitter is attached. Routing the cables back to the panel, therefore, requires a rather sharp bend in the cable.

### SUMMARY

According to one aspect of the present disclosure, a carrier for a fiber optic cable splitter includes at least one fastener extending in a first direction for attaching the carrier to a mounting plate. The carrier is configured to hold the cable splitter oriented such that cable can enter and exit the cable splitter in a second direction substantially perpendicular to the first direction.

According to another aspect of the present disclosure, a method is provided for installing fiber optic cable in a fiber distribution hub having a mounting plate substantially lying in a plane, a fiber optic cable splitter supported by the mounting plate, and at least one cable routing element. The method includes routing at least one fiber cable to the fiber optic splitter using the cable routing element, the fiber cable extending from the routing element to the fiber cable splitter in a direction substantially parallel to the plane of the mounting plate.

According to yet another aspect of the present disclosure, a fiber distribution hub for dividing and distributing fiber optic cables includes a mounting plate lying in a plane, at least one splitter carrier attached to the mounting plate, and a fiber optic splitter supported by the splitter carrier such that fiber cables can be connected to the fiber optic splitter in a direction generally parallel to the plane of the mounting plate when the fiber cables are installed in the fiber distribution hub.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is an isometric view of a fiber optic cable splitter and carrier.

FIG. 2 is an isometric view of a fiber optic cable splitter mounted on a carrier.

FIG. 3 is an isometric view of a fiber distribution hub mounting plate having a fiber optic cable splitter and carrier attached.

FIG. 4 is an isometric view of a fiber distribution hub mounted on a pedestal and including a mounting plate having a fiber optic cable splitter and carrier attached

### DETAILED DESCRIPTION

The following description is merely exemplary in nature and is not intended to limit the present disclosure, application, or uses. It should be understood that throughout the drawings, corresponding reference numerals indicate like or corresponding parts and features.

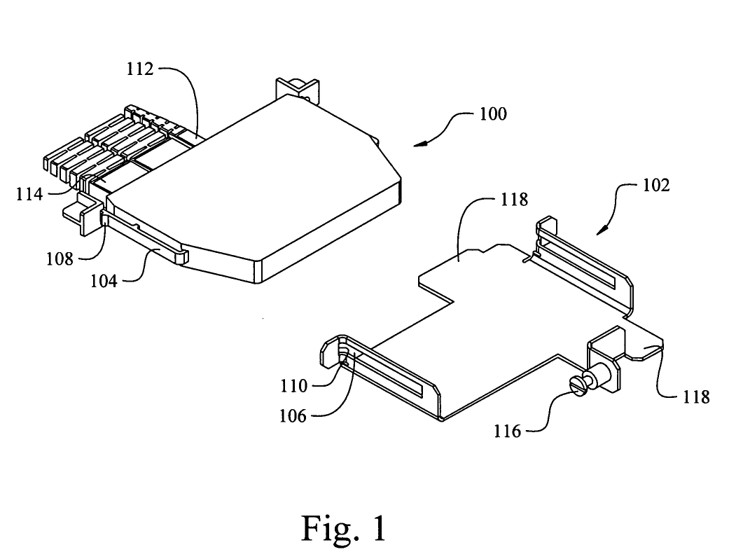

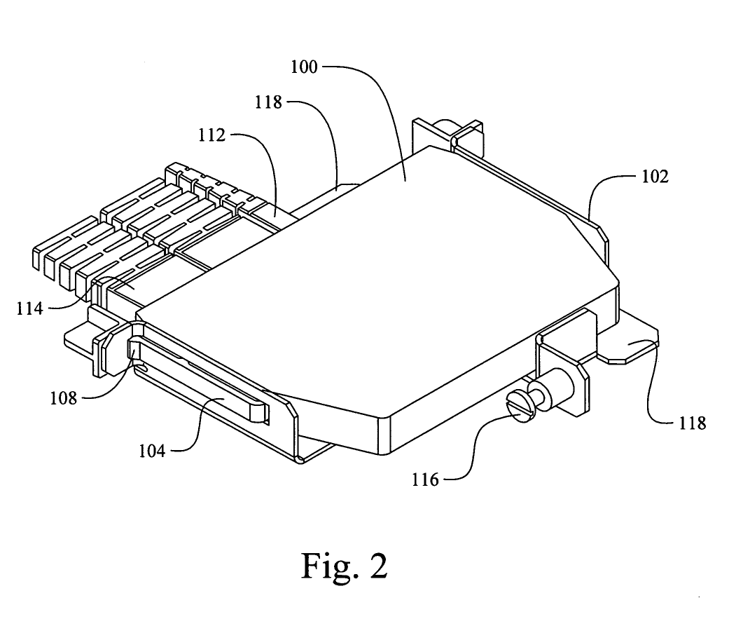

FIGS. 1 and 2 illustrate a fiber optic splitter, generally indicated by the reference numeral 100 and a fiber optic cable splitter carrier 102. FIG. 1 illustrates the splitter and carrier separately. The carrier is configured to receive and retain the splitter and FIG. 2 illustrates the splitter mounted in the carrier. The exact configuration varies depending upon the configuration of the specific splitter to be used. The splitter of FIGS. 1 and 2 includes two flexible, snap-fit tabs 104. The carrier includes two slots 106 to receive the tabs. When the splitter is moved onto the carrier the tabs slide into the slots. When the splitter is nearly completely seated on the carrier, the locking portion 108 of the tabs is forced to flex inward. Once the locking portion completely passes the edge 110, the tab can flex outward and lock the splitter in place on the carrier.

The splitter includes at least one input port 112 and a plurality of output ports 114. The input port and output ports of the splitter in FIG. 1 are shown with a portion of fiber optic cable attached. Data traveling on the fiber optic cable entering the splitter input port is split and output to the plurality of output ports.

According to some embodiments, the splitter is a 1×32 modular optical splitter. The splitter may be pre-terminated with SC/APC type connectors and use bend insensitive fiber. The splitter may further, or alternatively, include pre-parked pigtails for fiber storage.

According to still other embodiments, the splitter has an operating wavelength of 1260 to 1600 nanometers. The splitter may also have a maximum insertion loss of about 17.5 decibels (dB), uniformity less than or equal to 1.5 dB, a return loss greater than or equal to 55 dB, directivity greater than 60 dB, and polarization dependent loss (PDL) less than or equal to 0.30 dB.

A fastener 116 for securing the splitter and carrier to a mounting plate is provided on the splitter carrier. This fastener can be any type of fastener, such as a screw or bolt, capable of securing the carrier to the mounting plate.

The splitter carrier also includes two guide tabs 112. These tabs extend from the carrier beyond the perimeter of the splitter when it is mounted in the carrier. The guide tabs fit into matching slots in the mounting plate to which the splitter is to be attached.

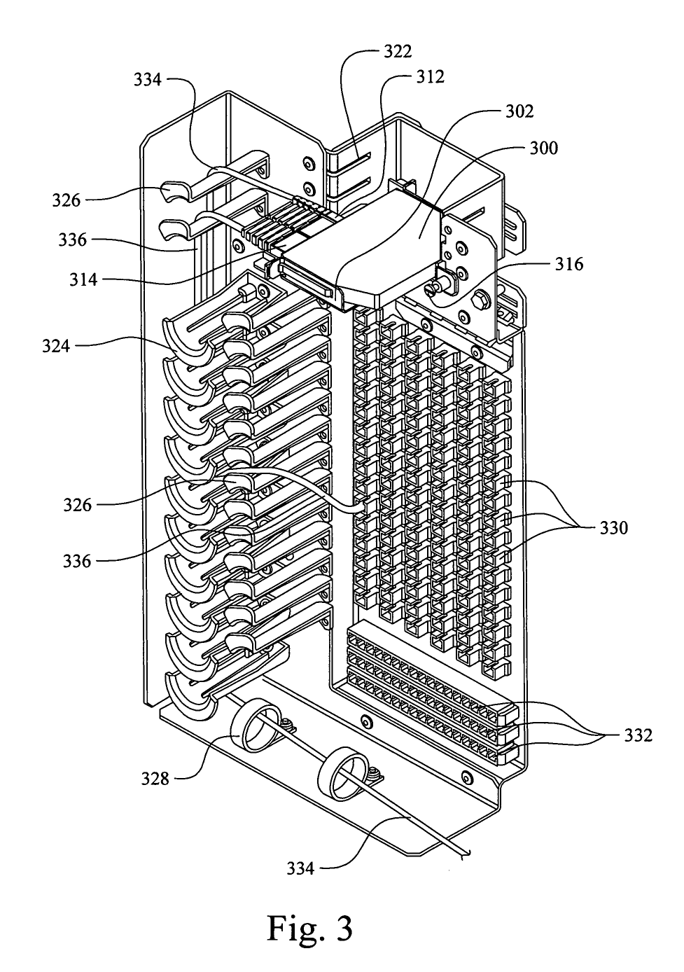

A mounting plate 320 for a fiber distribution hub is illustrated in FIG. 3. The mounting plate has three sets of carrier mounting slots 322. The mounting plate also includes several wire management elements. These elements include half spools 324, crescent spools 326 and cable guides 328. The mounting plate also includes connection points 330 for making fiber optic cable connections and parking points 332 for retaining unused fiber optic cables for later use.

A fiber optic splitter 300 is also mounted on the mounting plate. More specifically, the fiber optic splitter is supported by a fiber optic splitter carrier 302 and the carrier is attached to the mounting plate. The guide tabs of the carrier, not visible, slide in and are supported by the carrier mounting slots. A fastener 316 on the carrier holds the carrier in place against the mounting plate.

The splitter carrier orients the splitter in an optimal orientation relative to the mounting plate. The splitter is oriented such that an input port 312 and output ports 314 do not face perpendicular to the mounting plate, i.e. when facing the mounting plate straight on, the input and output ports face to the left or right. Cable enters and exits the splitter in a plane parallel to the plane of the mounting plate. For example, a fiber optic cable 334 is routed along the bottom of the mounting plate through the cable guides, around at least one of the half spools and up the side of the mounting plate. The cable is then routed over one of the crescent spools and directly into the input port. Thus, as cable travels from the cable guide to the input port, the cable does not have any bends toward the mounting plate.

Similarly, a fiber jumper cable 336 is routed straight out of the exit port and around a crescent spool. After being routed to the desired vertical level, the jumper cable travels around one of the half spools and one of the interior crescent spools. When the jumper cable is located at the desired termination, such as a connection point, the jumper cable is bent toward the mounting plate and the fiber can then be terminated. Thus, as cable travels from the output port to a connection point or parking point on the mounting plate, the cable need only bend toward the mounting plate once.

Although only one splitter and carrier is shown attached to the mounting plate, more than one splitter and carrier can be mounted on the mounting plate. The mounting plate includes three sets of carrier mounting slots and can hold three splitters, each mounted on a separate carrier. Additionally, or alternatively, more or fewer carriers and splitters can be accommodated by different mounting plate configurations.

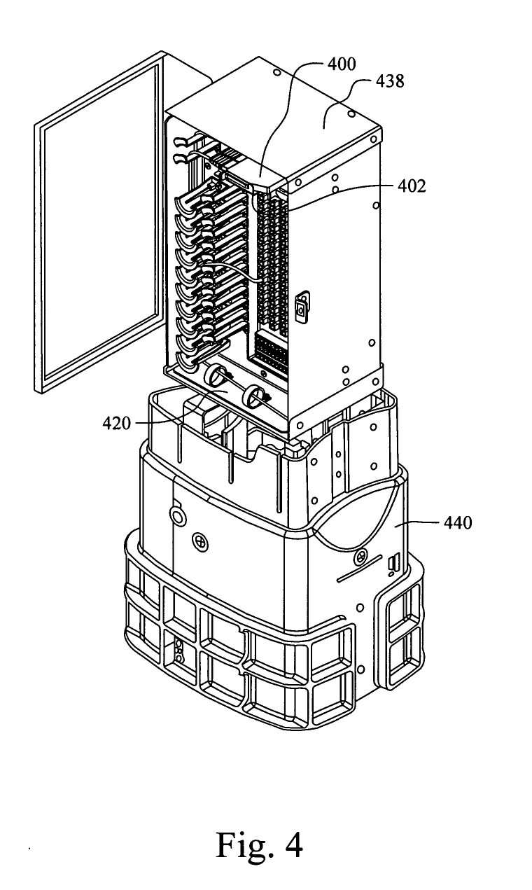

A mounting plate 420 is shown mounted in a fiber distribution hub 438 in FIG. 4. The mounting plate includes a fiber optic splitter 400 supported by a carrier 402. The carrier is attached to the mounting plate in the manner discussed above. The fiber distribution hub is mounted on a telecommunications pedestal 440

The description herein is merely exemplary in nature and, thus, variations that do not depart from the gist of that which is described are intended to be within the scope of the teachings. Such variations are not to be regarded as a departure from the spirit and scope of the teachings.

1. A carrier for a fiber optic cable splitter, the carrier comprising at least one fastener extending in a first direction for attaching the carrier to a mounting plate, the carrier configured to hold the cable splitter oriented such that cable can enter and exit the cable splitter in a second direction substantially perpendicular to the first direction.

2. The carrier of claim 1 further comprising a snap fit connector for mounting the cable splitter to the carrier.

3. The carrier of claim 1 further comprising at least one guide tab for supporting the carrier when the carrier is installed on a mounting plate having a matching slot for receiving the guide tab.

4. A method of installing fiber optic cable in a fiber distribution hub having a mounting plate substantially lying in a plane, a fiber optic cable splitter supported by the mounting plate, and at least one cable routing element, the method comprising routing at least one fiber cable to the fiber optic splitter using the cable routing element, the fiber cable extending from the routing element to the fiber cable splitter in a direction substantially parallel to the plane of the mounting plate.

5. The method of claim 4 further comprising routing the fiber optic cable into the fiber distribution hub.

6. The method of claim 4 wherein the fiber distribution hub includes a carrier for supporting the fiber optic cable splitter and the carrier is mounted to the mounting plate.

7. The method of claim 4 wherein routing at least one fiber cable includes routing the fiber cable in at least first direction, a second direction and a third direction, the first direction and the second direction substantially perpendicular, the second and the third direction substantially perpendicular, the first and third direction being substantially perpendicular and the first, second and third directions all lying within a second plane substantially parallel to the plane of the mounting plate.

8. The method of claim 7 wherein the at least one cable routing element is a plurality of cable routing elements and the cable routing elements are utilized in routing the fiber cable from each of the first direction to the second direction and the second direction to the third direction.

9. The method of claim 4 wherein the cable routing element is a radius limiting spool.

10. The method of claim 9 wherein the spool is attached to the mounting plate and located such that the cable is routed around the spool and directly into the fiber cable splitter.

11. The method of claim 4 further comprising routing a second fiber optic cable out of the splitter to a connection point on the mounting plate using the cable routing element, the second fiber optic cable connecting to the connection point in a direction substantially perpendicular to the plane of the mounting plate.

12. A fiber distribution hub for dividing and distributing fiber optic cables, the fiber distribution hub comprising a mounting plate lying in a plane, at least one splitter carrier attached to the mounting plate, and a fiber optic splitter supported by the splitter carrier such that fiber cables can be connected to the fiber optic splitter in a direction generally parallel to the plane of the mounting plate when the fiber cables are installed in the fiber distribution hub.

13. The fiber distribution hub of claim 12 further comprising a plurality of fiber connection points for terminating fiber cables, the fiber cables connected to the fiber connection points in a direction generally perpendicular to the plane of the mounting plate when the fiber cables are installed in the fiber distribution hub.

14. The fiber distribution hub of claim 12 further comprising at least one cable routing element adapted to guide the fiber optic cables within the fiber distribution hub when the fiber cables are installed in the fiber distribution hub.

15. The fiber distribution hub of claim 12 wherein the at least one splitter carrier comprises a plurality of splitter carriers.
